(19) United States
(12) Patent Application Publication
(10) Pub. No.: US 2003/0217425 A1
(43) Pub. Date: Nov. 27, 2003

(54) Wipe with finger pockets

(75) Inventors: Paul Joseph Datta, Appleton, WI (US); Cindy Lou Price, Appleton, WI (US); Nancy Lynn Steffen, Racine, WI (US)

Correspondence Address: Glen P. Belvis, Brinks Hofer Gilson & Lione, P.O. Box 10395, Chicago, IL, 60610, US

(73) Assignee: Kimberly Clark Worldwide Inc.

(21) Appl. No.: 10/155,449

(22) Filed: May 23, 2002

(51) Int. Cl. A47L 13/18; B32B 31/00

(52) U.S. Cl. 15/227; 156/73.1; 156/308.4; 156/290

(57) ABSTRACT

A wipe product includes a primary sheet of material bonded to a secondary sheet of material, with pockets formed between the bonds. The wipe product may be used by placing a user's fingers in the pockets and wiping a surface. The pockets can provide for coverage of the user's hand and for stabilization of the wipe on the user's hand.

### BACKGROUND

In cleaning surfaces, it is often useful to contact the surface with a disposable wipe product. Common examples of disposable wipe products include tissue paper, such as facial tissue and bath tissue; paper towels; premoistened wipes; and wipes containing agents such as cleaning agents, therapeutic agents, or moisture which are encapsulated or otherwise incorporated into the wiping product. Surfaces which can be cleaned by contact with a wipe product include inanimate surfaces such as furniture; countertops; walls; floors; bathroom and kitchen fixtures; electronic equipment including housings and displays; interiors and exteriors of automobiles, trains, aircraft, watercraft and spacecraft; windows; industrial equipment; and electronic boards. These surfaces may, for example, contain wood, fibers, plastic, metal, cloth, ceramic, glass, paint, or minerals. Surfaces which can be cleaned by contact with a wipe product also include biological surfaces, including animal body surfaces such as skin, hair, fingernails, and toenails; and the surfaces of vegetables, fruits, grains, and meats.

One drawback to the use of conventional wipe products is the lack of control when removing substances from the surface. This is especially problematic when removing substances which are particularly difficult to remove or which are odious to the user. For example, in cleaning grease or oil from machine surfaces, it is often undesirable for the user's hand to be in contact with the grease or oil to be removed, as these substances are difficult to remove from the skin. Likewise, in cleaning common body soils a user is typically careful to avoid bodily contact with the soils.

Disposable wipe products have been described which provide for some coverage of the hand of the user during the cleaning process. For example, a sheet product may be folded to form a pocket such that the user's hand can be inserted into the pocket before cleaning. In this way, both the top and bottom of the user's hand are at least partially covered by the sheet product. Although simple and easy to manufacture, a disadvantage of this “mitten” approach is the tendency of the wipe product to be displaced relative to its initial position on the hand. The displacement is particularly likely during the actual wiping process, due to the stresses that the wipe encounters when contacted with the surface.

In another example, one or more sheets of material may be cut and then fastened together to form a glove, as described in U.S. Pat. No. 5,127,127. This “glove” approach, however, is complicated, and thus difficult and expensive to manufacture. Both the “mitten” and the “glove” approaches produce wipe products which are difficult to place on a user's hand prior to cleaning and to remove from the user's hand after the product has been used to clean a surface. Typically, these products cannot be placed onto or removed from a user's hand without the use of both of the user's hands.

It is thus desirable to provide disposable wipe products which provide coverage for the user's hand during cleaning while remaining stable on the hand, and which also are easy and inexpensive to manufacture. It is particularly desirable that the wipe products can be made using existing sheet-processing equipment.

### BRIEF SUMMARY

In an embodiment of the invention, there is provided a disposable wipe product, comprising a primary sheet comprising an upper edge, a lower edge, a right side edge, a left side edge, and a width extending between the side edges; a secondary sheet comprising an upper edge, a lower edge, a right side edge, a left side edge, and a width extending between the side edges; at least a portion of the upper edge of the primary sheet connected to at least a portion of the upper edge of the secondary sheet; at least a portion of the right side edge of the primary sheet connected to at least a portion of the right side edge of the secondary sheet; and at least a portion of the left side edge of the primary sheet connected to at least a portion of the left side edge of the secondary sheet; at least one bond connecting the width of the primary sheet with the width of the secondary sheet; a space between the right side edges and the at least one bond; and a space between the left side edges and the at least one bond; wherein the at least one bond is positioned between the right side edges and the left side edges, and the width of the primary sheet is about equal to the width of the secondary sheet.

These embodiments may further comprise a wipe product comprising at least two bonds connecting the width of the primary sheet with the width of the secondary sheet; comprising at least three bonds connecting the width of the primary sheet with the width of the secondary sheet; and comprising at least four bonds connecting the width of the primary sheet with the width of the secondary sheet. These embodiments may yet further comprise a wipe product wherein the primary sheet is an absorbent material; wherein the secondary sheet is an absorbent material; wherein the primary sheet and secondary sheet are nonwoven; wherein the upper edge of the primary sheet and the upper edge of the secondary sheet are connected by a fold; wherein the upper edge of the primary sheet and the upper edge of the secondary sheet are connected by a bond; and wherein the primary sheet has a length of at least about 3 inches, the secondary sheet has a length of at least about 0.5 inch, and the wipe product has a width of at least 3 inches.

These embodiments may further comprise a wipe product further comprising a tertiary sheet comprising an upper edge, a lower edge, a right side edge, a left side edge, and a width extending between the side edges; at least a portion of the lower edge of the primary sheet connected to at least a portion of the upper edge of the tertiary sheet; at least a portion of the right side edge of the primary sheet connected to at least a portion of the right side edge of the tertiary sheet; and at least a portion of the left side edge of the primary sheet connected to at least a portion of the left side edge of the tertiary sheet; and at least one bond connecting the width of the primary sheet with the width of the tertiary sheet; wherein the at least one bond is positioned between the right side edges and the left side edges, and the width of the primary sheet is about equal to the width of the tertiary sheet. These embodiments may yet further comprise a wipe product wherein the primary sheet has a first side and a second side; the secondary sheet connected to the first side, and the tertiary sheet connected to the second side. These embodiments may yet further comprise a wipe product wherein the primary sheet has a first side and a second side; the secondary sheet and the tertiary sheet connected to the first side.

In another embodiment of the invention, there is provided a method of making a wipe product, comprising providing a primary sheet and a secondary sheet; the primary sheet comprising an upper edge, a lower edge, a right side edge, a left side edge, and a width extending between the side edges; the secondary sheet comprising an upper edge, a lower edge, a right side edge, a left side edge, and a width extending between the side edges; at least a portion of the upper edge of the primary sheet connected to at least a portion of the upper edge of the secondary sheet; and the width of the primary sheet about equal to the width of the secondary sheet; connecting at least a portion of the right side edge of the primary sheet to at least a portion of the right side edge of the secondary sheet; connecting at least a portion of the left side edge of the primary sheet to at least a portion of the left side edge of the secondary sheet; and forming at least two spaces by connecting the primary sheet with the secondary sheet at one or more positions between the right side edges and the left side edges.

These embodiments may further comprise a method wherein the providing comprises folding a sheet of material along a line to form the primary sheet and the secondary sheet; wherein the primary sheet and the secondary sheet are at least partially connected along the line. These embodiments may further comprise a method wherein the providing comprises bonding at least a portion of the upper edge of the primary sheet with at least a portion of the upper edge of the secondary sheet.

These embodiments may yet further comprise a method wherein the forming at least two spaces comprises forming three spaces by connecting the primary sheet with the secondary sheet at two positions between the right side edges and the left side edges; wherein the forming at least two spaces comprises forming four spaces by connecting the primary sheet with the secondary sheet at three positions between the right side edges and the left side edges; wherein the forming at least two spaces comprises forming five spaces by connecting the primary sheet with the secondary sheet at four positions between the right side edges and the left side edges; wherein the connecting at least a portion comprises application of adhesives, thermal bonding, taping, mechanical fastening, ultrasonic bonding, or entanglement of elements of the sheets; wherein the primary sheet comprises a first width extending between the side edges; the secondary sheet comprises a second width extending between the side edges; and the first width is about equal to the second width; and wherein the primary sheet and secondary sheet are nonwoven.

In another embodiment of the invention, there is provided a method of making a plurality of wipe products, comprising providing a primary sheet and a secondary sheet traveling in a machine direction; the primary sheet comprising an upper edge and a lower edge; the secondary sheet comprising an upper edge and a lower edge; at least a portion of the upper edge of the primary sheet connected to at least a portion of the upper edge of the secondary sheet; connecting the primary sheet and the secondary sheet with intermittent bonds at an angle relative to the machine direction; and forming a plurality of separations in a cross direction perpendicular to the machine direction; wherein, in a region between two proximal separations, at least two pockets are positioned between the intermittent bonds.

These embodiments may further comprise a method wherein the forming a plurality of separations comprises cutting the primary and secondary sheets in the cross direction; wherein the forming a plurality of separations comprises perforating the primary and secondary sheets in the cross direction; wherein the providing comprises folding a sheet of material along a line in the machine direction to form the primary sheet and the secondary sheet; wherein the primary sheet and the secondary sheet are at least partially connected along the line; wherein the providing comprises bonding at least a portion of the upper edge of the primary sheet with at least a portion of the upper edge of the secondary sheet with an edge bond in the machine direction; wherein three pockets are positioned between the intermittent bonds; wherein four pockets are positioned between the intermittent bonds; wherein five pockets are positioned between the intermittent bonds; wherein the connecting and/or bonding comprises application of adhesives, thermal bonding, taping, mechanical fastening, ultrasonic bonding, or entanglement of elements of the sheets; and wherein the primary sheet and secondary sheet are nonwoven.

In another embodiment of the invention, there is provided a disposable wipe product, comprising: a primary sheet comprising an upper edge, a lower edge, a right side edge, a left side edge, and a width extending between the side edges; a secondary sheet comprising an upper edge, a lower edge, a right side edge, a left side edge, and a width extending between the side edges; wherein at least a portion of the upper edge of the primary sheet is connected to at least a portion of the upper edge of the secondary sheet; and the width of the primary sheet is about equal to the width of the secondary sheet; a first bond, connecting the width of the primary sheet with the width of the secondary sheet near the right side edges; a second bond, connecting the width of the primary sheet with the width of the secondary sheet near the left side edges; a third bond, connecting the width of the primary sheet with the width of the secondary sheet and positioned between the first and second bonds; at least one space between the first bond and the third bond; and at least one space between the second bond and the third bond.

These embodiments may further comprise a wipe product further comprising a fourth bond, connecting the width of the primary sheet with the width of the secondary sheet and positioned between the first bond and the third bond; at least one space between the first bond and the fourth bond; and at least one space between the third bond and the fourth bond. These embodiments may yet further comprise a wipe product comprising a fifth bond, connecting the width of the primary sheet with the width of the secondary sheet and positioned between the second bond and the third bond; at least one space between the second bond and the fifth bond; and at least one space between the third bond and the fifth bond.

In another embodiment of the invention, there is provided a method of making a wipe product, comprising providing a primary sheet and a secondary sheet; the primary sheet comprising an upper edge, a lower edge, a right side edge, and a left side edge; the secondary sheet comprising an upper edge, a lower edge, a right side edge, and a left side edge; at least a portion of the upper edge of the primary sheet connected to at least a portion of the upper edge of the secondary sheet; forming a first bond to connect the width of the primary sheet with the width of the secondary sheet near the right side edges; forming a second bond to connect the width of the primary sheet with the width of the secondary sheet near the left side edges; and forming a third bond to connect the width of the primary sheet with the width of the secondary sheet at a position between the first and second bonds; wherein the first bond and the third bond are separated by at least one space; the second bond and the third bond are separated by at least one space; and the width of the primary sheet is about equal to the width of the secondary sheet.

These embodiments may further comprise a method further comprising forming a fourth bond to connect the width of the primary sheet with the width of the secondary sheet at a position between the first and third bonds; wherein the first bond and the fourth bond are separated by at least one space; and the fourth bond and the third bond are separated by at least one space. These embodiments may yet further comprise a method further comprising forming a fifth bond to connect the width of the primary sheet with the width of the secondary sheet at a position between the second and third bonds; wherein the second bond and the fifth bond are separated by at least one space; and the fifth bond and the third bond are separated by at least one space.

In another embodiment of the invention, there is provided a disposable wipe product, consisting essentially of a primary sheet comprising an upper edge, a lower edge, a right side edge, and a left side edge; a secondary sheet comprising an upper edge, a lower edge, a right side edge, and a left side edge; at least a portion of the upper edge of the primary sheet connected to at least a portion of the upper edge of the secondary sheet; at least a portion of the right side edge of the primary sheet connected to at least a portion of the right side edge of the secondary sheet; and at least a portion of the left side edge of the primary sheet connected to at least a portion of the left side edge of the secondary sheet; a bond connecting the primary sheet with the secondary sheet and positioned between the right side edges and the left side edges; a space between the right side edges and the bond; and a space between the left side edges and the bond.

In another embodiment of the invention, there is provided a disposable wipe product, comprising: a primary sheet comprising an upper edge, a lower edge, a right side edge, and a left side edge; a secondary sheet comprising an upper edge, a lower edge, a right side edge, and a left side edge; at least a portion of the upper edge of the primary sheet connected to at least a portion of the upper edge of the secondary sheet; at least a portion of the right side edge of the primary sheet connected to at least a portion of the right side edge of the secondary sheet; and at least a portion of the left side edge of the primary sheet connected to at least a portion of the left side edge of the secondary sheet; at least one bond connecting the primary sheet with the secondary sheet; a space between the right side edges and the at least one bond; and a space between the left side edges and the at least one bond; wherein the at least one bond is positioned between the right side edges and the left side edges, and the at least one bond and the upper edges are not adjacent.

### BRIEF DESCRIPTION OF THE DRAWINGS

FIG. 1 is a diagram of a sheet which is unfolded.

FIG. 2 is a diagram of a sheet which is partially folded.

FIG. 3 is a diagram of a sheet which is completely folded.

FIG. 4 is a perspective diagram of a wipe product with two finger pockets.

FIG. 5 is a perspective diagram of two separate sheets bonded together.

FIGS. 6-8 are diagrams of separate sheets bonded together.

FIGS. 9-10 are diagrams of wipe products having two sets of finger pockets.

FIGS. 11-14 are diagrams of wipe products having from two to five finger pockets.

FIGS. 15-16 are diagrams of wipe products having various bonding configurations.

FIGS. 17-19 are diagrams of wipe products having various primary and secondary sheet configurations.

FIG. 20 is a diagram of a wipe product having a design.

FIGS. 21-22 are diagrams of a process of making a wipe product.

FIGS. 23-24 are diagrams of a process of making a wipe product.

FIG. 25 is a perspective diagram of a wipe product.

FIG. 26 is a stylized illustration of the progress of a wipe product manufacturing process.

FIG. 27 is a stylized illustration of the progress of a wipe product manufacturing process.

### DETAILED DESCRIPTION

A disposable wipe product is provided which includes a primary sheet of material bonded to a secondary sheet of material, with pockets formed between the bonds. The wipe product may be used by placing a user's fingers in the pockets and wiping a surface. The pockets can provide for coverage of the user's hand and for stabilization of the wipe on the user's hand. The wipe product may have a variety of configurations and may be made from a wide range of sheet materials. The disposable wipe product may be easily removed from the user's hand after use, including removal without the use of the hand which is not placed in the wipe. The term “disposable” refers to an article which is intended to be discarded after a single use.

One or more sheet materials may be used to form the wipe product. Sheet materials which are useful include fibrous webs, i.e. paper sheets. For example, a sheet material may be a nonwoven basesheet, such as a dry-formed basesheet or a wet-laid basesheet, including tissue and towel basesheets. A sheet material may be an airlaid, spun-laid, hydroentangled, spun-bond, or melt-blown (for example, coform) basesheet. A sheet material may be a multi-layer basesheet, such as a laminate of any combination of these basesheets. A sheet material may contain a binder, for example a non-dispersible binder, such as a latex binder or a cross-linkable binder; or a water-dispersible binder, such as a temperature-sensitve water dispersible binder or an ion-sensitive water dispersible binder.

The term “nonwoven” means a web having a structure of individual fibers or threads which are interlaid, but not in a regular or identifiable manner as in a knitted fabric. Nonwoven fabrics or webs may be formed from many processes including, for example, meltblowing processes, spun-bonding processes, air laying processes, and bonded carded web processes.

The term “coform” refers a process in which at least one meltblown diehead is arranged near a chute through which other materials are added to the web while it is forming. Such other materials may be pulp, superabsorbent particles, natural polymers (for example, rayon or cotton fibers) and/or synthetic polymers (for example, polypropylene or polyester) fibers, for example, where the fibers may be of staple length. Coform processes are described in U.S. Pat. Nos. 4,818,464 and 4,100,324, which are both commonly assigned to Kimberly-Clark. Webs produced by the coform process are generally referred to as coform materials.

An example of a useful sheet material is Kimberly-Clark Supreme Care TM baby wipes (KIMBERLY-CLARK CORPORATION, Neenah, Wis.), as described in U.S. patent application Ser. No. 09/751,329, entitled “Composite Material With Cloth-Like Feel”, filed Dec. 29, 2000, which is commonly assigned to Kimberly-Clark. This type of basesheet contains coform blended with polypropylene fibers and fluff.

The sheet materials can be provided as dry sheets or moist sheets. The sheet materials can be further treated during or after the formation of the wipe product. Examples of treatments include embossing, cutting, folding, impregnation with additives, application of binders, application of moisture, and application of agents such as lotions, therapeutic substances, cleaning agents, and agents for sanitization and/or sterilization.

The disposable wipe product may be a wet wipe. Wet wipes can be any wipe, towel, tissue or sheet like product including natural fibers, synthetic fibers, synthetic material and combinations thereof, that is wet or moist or becomes wet during use or prior to use. Wet wipes may be dispersible when in contact with water or may be non-dipsersible.

If more than one sheet of material is used to make a wipe product, the individual sheets may be the same, or they may be different. For example, a highly absorbent sheet may be used as the primary sheet, and a nonabsorbent sheet may be used as the secondary sheet. In this way, cleaning can be accomplished by contacting a surface with the primary sheet, and the secondary sheet may function simply to protect the user's hand. In another example, identical sheets appropriate for cleaning can be used for both the primary and secondary sheets, thus allowing either or both sheets to be used for cleaning. In another example, one sheet may be rough and the other sheet may be smooth, thus providing for different degrees of cleaning or polishing. It may be advantageous for absorbent sheet materials to be used for at least the primary sheet material. It may also be advantageous for absorbent sheet materials to be independently used for both the primary and secondary sheet materials.

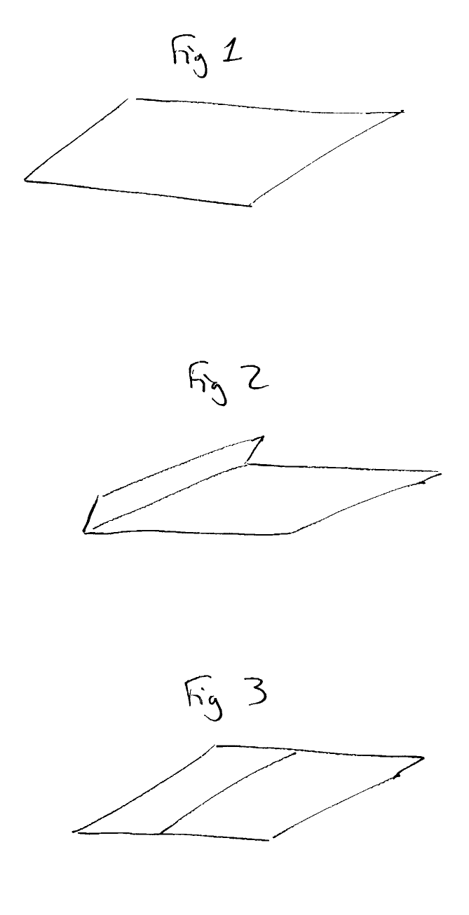

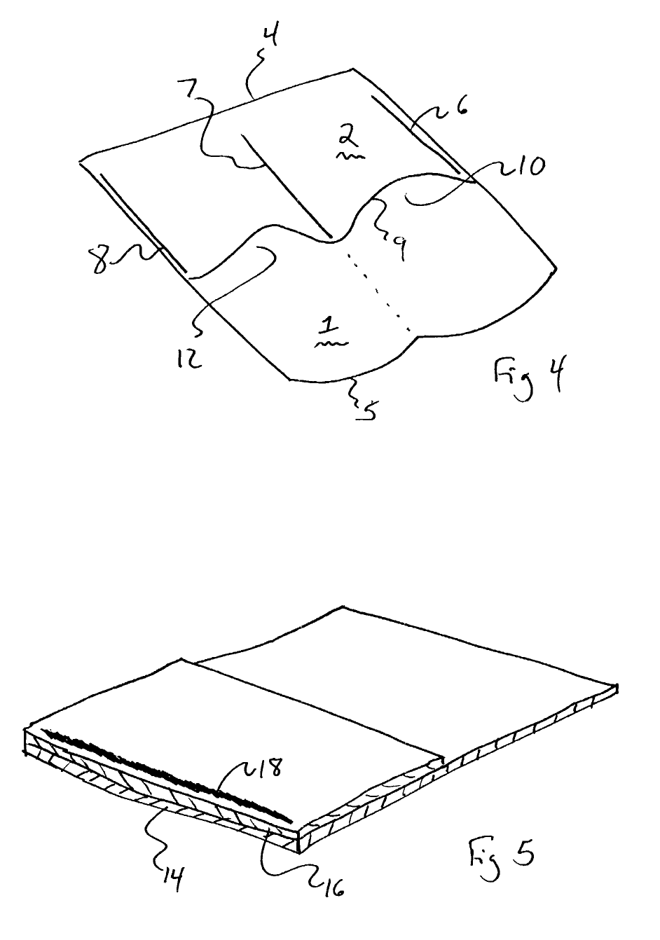

Wipe products can be formed from a single sheet or from more than one sheet. In general, a single sheet can be formed into a wipe product by first folding one edge of the sheet. In this way, the portion which is folded is referred to as the secondary sheet, and the portion onto which the secondary sheet is folded is referred to as the primary sheet. FIGS. 1, 2, and 3 are diagrams of a single sheet which is unfolded, partially folded, and completely folded, respectively. The primary and secondary sheets are then bonded together intermittently.

Referring to FIG. 4, the fold line, the bonds, and the primary and secondary sheets thus define pockets. FIG. 4 illustrates an example of a wipe product having two pockets. In this example, secondary sheet 2 has been formed by folding the edge of the single sheet over the primary sheet 1, along fold line 4. Bonds 6, 7, and 8 connect the primary and secondary sheets to help form pockets 10 and 12.

Referring still to FIG. 4, the fold line 4 is located at the upper edges of the primary and secondary sheets. The primary sheet has a lower edge 5, and the secondary sheet has a lower edge 9. Bond 6 is located at or near the right side edges of the primary and secondary sheets, and bond 8 is located at or near the left side edges of the primary and secondary sheets. Thus, the fold line 4 extends along the widths of the primary and secondary sheets, between the right side edges and the left side edges. Bond 7 is positioned between the right side edges and the left side edges. The space between bond 6 and bond 7 functions as pocket 10, and the space between bond 7 and bond 8 functions as pocket 12.

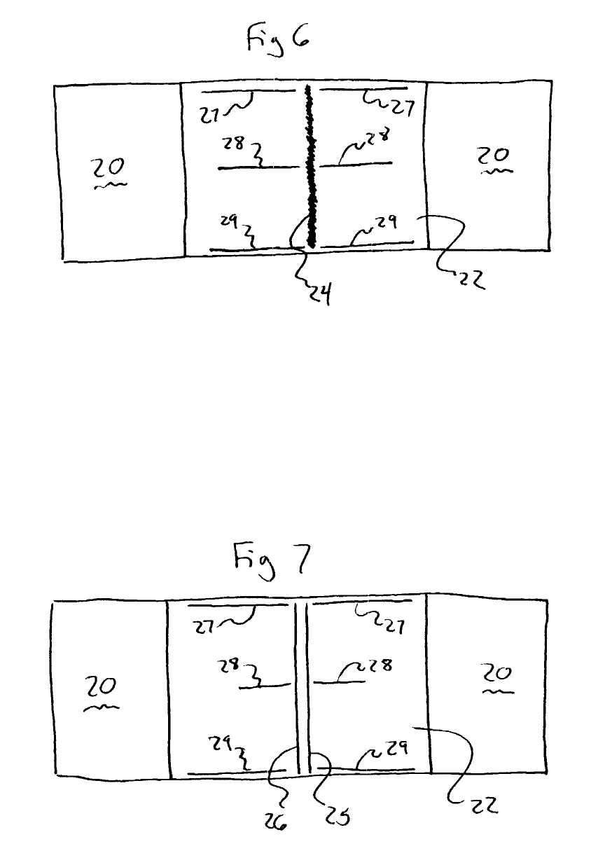

More than one sheet of material can also be used to form a wipe product. Separate sheets of primary sheet material and secondary sheet material can be placed together and bonded. For example, referring to FIG. 5, the upper edge of a primary sheet material 14 can be aligned with the upper edge of a secondary sheet material 16, and the sheets can be bonded with bond 18 along these edges (sheet thicknesses not drawn to scale). If desired, any excess sheet material beyond the bond can be removed, for example by trimming.

In another example, referring to FIGS. 6 and 7, a secondary sheet material 22 can be placed in contact with a primary sheet material 20, such that there is a substantial amount of the primary sheet material on either side of the secondary sheet material. One or more bonds 24 (FIG. 6), 25 and 26 (FIG. 7) can be formed to connect the sheets. The bonded sheets can then be separated along bond 24 or between bonds 25 and 26 to form the upper edges of the wipe products. The remaining bonds 27, 28, and 29 may be formed at the same time as the upper edge bonds (24-26), or they may be formed before or after the upper edge bonds.

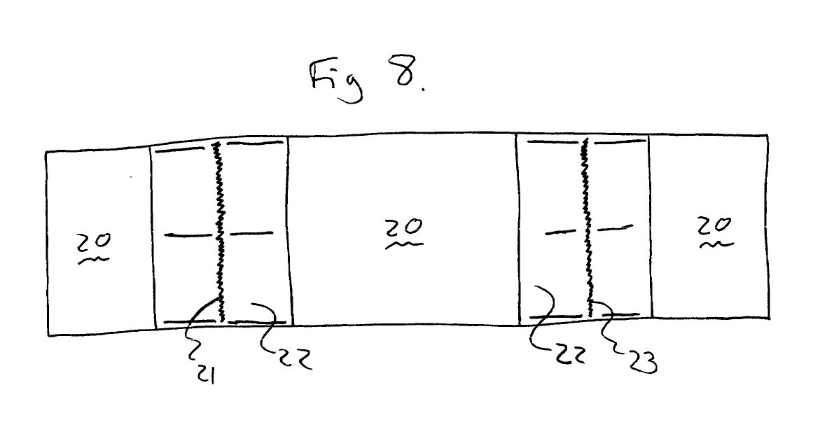

In another example, referring to FIG. 8, more than two sheets of material may be used. For example, two or more secondary sheets (which may be the same sheet material or different sheet materials) can be placed in contact with the primary sheet material, and one or more bonds can be formed. Separation along or between the bonds, as described above, as well as separation of the primary sheet material can result in a plurality of products which can be formed into wipe products with finger pockets by the application of appropriate bonds. Although FIG. 8 illustrates two secondary sheets, this process can be extended to utilize more than two secondary sheets.

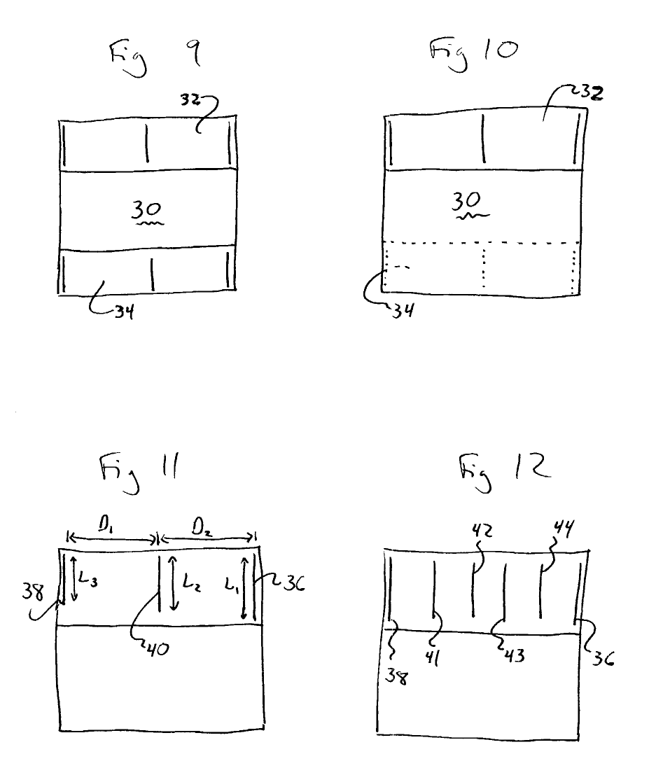

Pockets can be formed on both sides of the wipe product. For wipe products formed from a single sheet, the folding process can be performed on the opposite edge, that is on the lower edge of the primary sheet. Referring to FIGS. 9 and 10, the tertiary sheet thus formed, 34, may be on the same side of the primary sheet 30 as the secondary sheet 32 (FIG. 9), or it may be on the opposite side of the primary sheet (FIG. 10). The secondary sheet and the tertiary sheet may be the same size, or they may have different dimensions. The bonding on each side can be identical, or each side can have a different number, size, and/or configuration of bonds. For wipe products formed from more than one sheet, the placement and bonding of the secondary sheet and the tertiary sheet to the primary sheet can be done along two sides of the primary sheet. In another example, referring to FIG. 8, separation only along bonds 21 and 23 can provide two wipe products, each having a primary sheet and a secondary sheet, from the left and right perimeters and can provide one wipe product from the center having a primary, secondary and tertiary sheet.

Bonding of the sheets can be accomplished by a variety of common methods. Each bond can be configured as, for example, a single point, more than one point, a single line, or more than one line, and each point or line can have a variety of shapes. It may be desirable to use sheet materials with at least some polymer content to assist in the bonding process. Bonding may be accomplished, for example, by application of adhesives and/or co-adhesives; thermal bonding, such as through-air bonding and thermal point bonding; taping; mechanical fastening; ultrasonic bonding; and entanglement of elements of the sheets, such as needle punching and stitch bonding. If the sheet is to undergo further processing after bonding, it is desirable that the bond formed is stable to the subsequent processing conditions. For example, if the wipe product is treated to provide a wet wipe product, it is preferred that any adhesive used is not degraded by the treatment.

Through-air bonding (TAB) is a process of bonding a nonwoven bicomponent fiber web in which air which is sufficiently hot to melt one of is the polymers of which the fibers of the web are made is forced through the web. The air velocity is typically between 100 and 500 feet per minute and the dwell time typically may be as long as 6 seconds. The melting and resolidification of the polymer is believed to provide the bonding. Through air bonding has relatively restricted variability. Since through-air bonding TAB requires the melting of at least one component to accomplish bonding, it is restricted to webs with two components like conjugate fibers or those which include an adhesive. In a through-air bonder, air having a temperature above the melting temperature of one component and below the melting temperature of another component is directed from a surrounding hood, through the web, and into a perforated roller supporting the web. Alternatively, the through-air bonder may be a flat arrangement wherein the air is directed vertically downward onto the web. The operating conditions of the two configurations are similar, the primary difference being the geometry of the web during bonding. The hot air melts the lower melting polymer component and thereby forms bonds between the filaments to integrate the web.

Thermal point bonding involves passing a fabric or web of fibers to be bonded between a heated calender roll and an anvil roll. The calender roll is usually, though not always, patterned in some way so that the entire fabric is not bonded across its entire surface, and the anvil roll is usually flat. As a result, various patterns for calender rolls have been developed for functional as well as aesthetic reasons. Typically, the percent bonding area varies from around 10% to around 30% of the area of the fabric laminate web. As is well known in the art, the spot bonding holds the laminate layers together and also imparts integrity to each individual layer by bonding filaments and/or fibers within each layer.

Stitchbonding involves the stitching of a material in accordance with U.S. Pat. No. 4,891,957 to Strack et al. or U.S. Pat. No. 4,631,933 to Carey, Jr.

Ultrasonic bonding is a process performed, for example, by passing the fabric between a sonic horn and anvil roll as illustrated in U.S. Pat. No. 4,374,888 to Bornslaeger.

The intermittent bonds, that is the bonds which form the finger pockets along with the fold line or the upper edge bond, can have a variety of lengths and spacings. For example, referring to FIG. 11, the right edge bond 36, the left edge bond 38, and the middle bond 40, may have lengths L₁, L₂, and L₃ respectively which are independent of each other. The bond lengths may independently be varied according to concerns including manufacturing, consumer acceptance, and cleaning performance. The distances D, and D₂ between two bonds may also be varied. For example, referring to FIG. 12, the distances between bonds 38 and 41, between 41 and 42, between 42 and 43, between 43 and 44, and between 44 and 36 can all be the same, or they may be different. For example, it may be desirable to have larger pockets sized and positioned to accommodate larger fingers, such as the thumb and middle finger. The combination of bond lengths (L) and spacings (D) can be varied to provide for optimum control of the wipe during use.

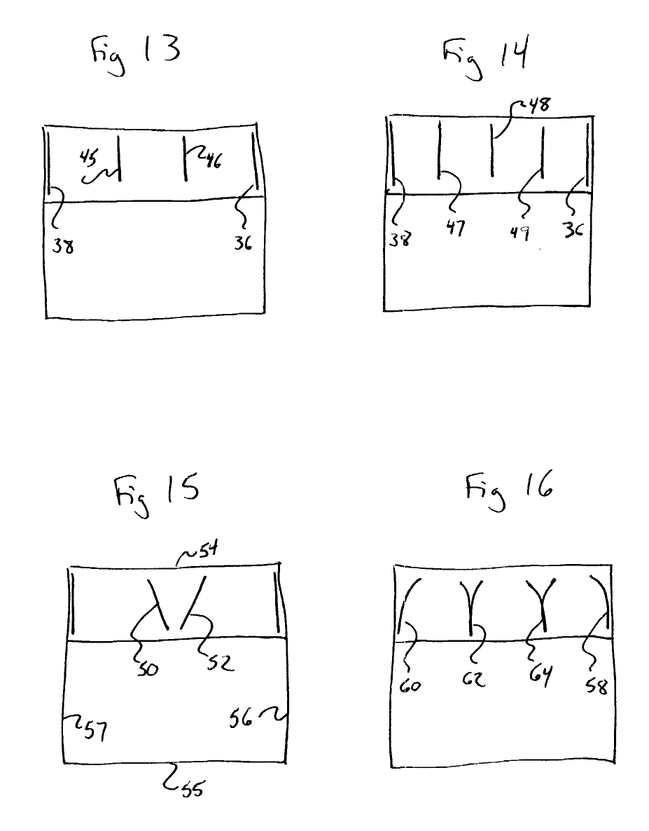

The number and position of bonds between the right edge bond and the left edge bond may be varied, as long as there is at least one bond present. For example, it may be desirable to have four or more bonds, so as to provide individual pockets for each finger of a user's hand. These bonds may be equally spaced, or the spacings between each pair may be independent. FIG. 12 illustrates a wipe product having four bonds (41,42, 43 and 44) between the right edge bond 36 and the left edge bond 38, thus forming five pockets. FIGS. 13 and 14 illustrate wipe products having two bonds (45 and 46, FIG. 13) and three bonds (47, 48 and 49; FIG. 14) between the right edge bond and the left edge bond.

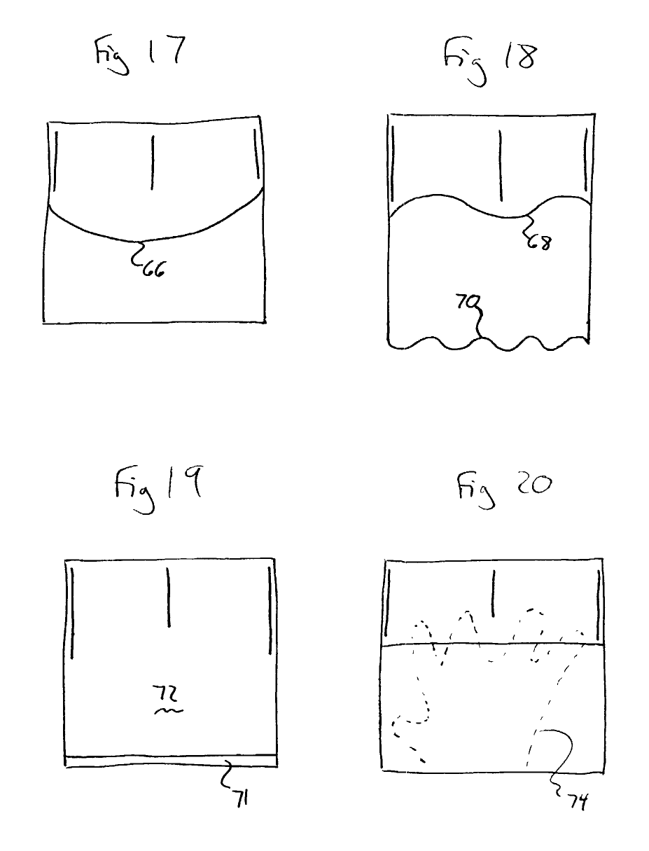

The configuration of an individual bond can also be independently varied. For example, referring to FIG. 15 an individual bond 50 or 52 can be set at an angle relative to the upper edge 54, the lower edge 55, the right edge 56, and the left edge 57. This particular configuration may be useful in allowing the user to insert the right two fingers between bond 52 and the right edge and to insert the left two fingers between bond 50 and the left edge. In another example, referring to FIG. 16 an individual bond can be non-linear, such as the curved edge bonds 58 and 60 and the curved intermittent bonds 62 and 64.

The length and shape of the primary sheet and the secondary sheet may be independently varied. Different configurations may provide for desirable combinations of protection and ease of insertion and removal of the user's hand. For example, referring to FIG. 17 the lower edge 66 of the secondary sheet may be non-linear. Referring to FIG. 18, both the lower edge 68 of the secondary sheet and the lower edge 70 of the primary sheet may be non-linear. Referring to FIG. 19, the secondary sheet 72 may only be slightly shorter than the primary sheet 71. This particular configuration may be desirable to provide greater protection of the user's hand. The difference in length of the primary and secondary sheets assists the user in inserting the hand into the product. The right and left edge bonds may extend the entire length of the secondary sheet, or they may extend for only a portion of the secondary sheet.

The wipe product may have other modifications, including the overall shape, configuration, and appearance of the wipe product. For example the wipe product may be embossed or printed with a design. Referring to FIG. 20, the design 74 may be for example a trademark, a message or a diagram of a hand.

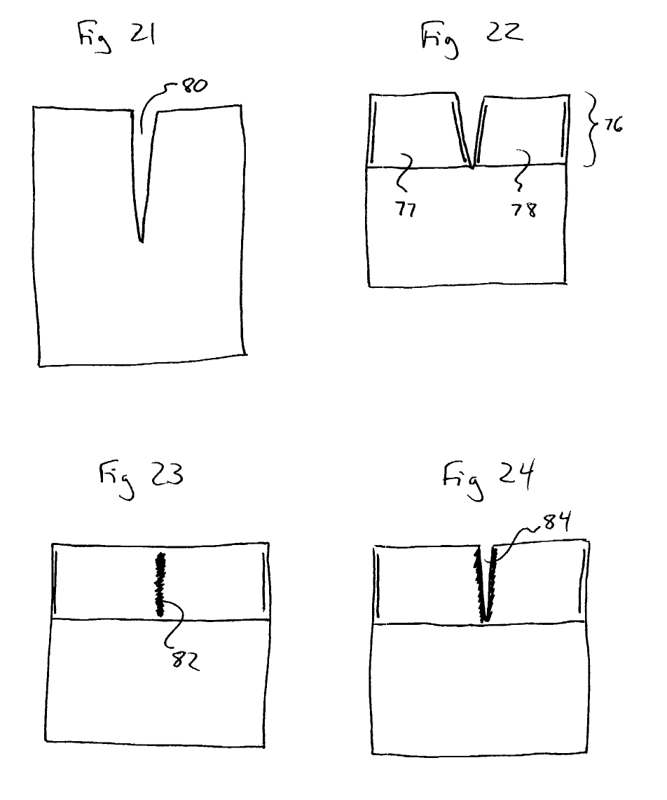

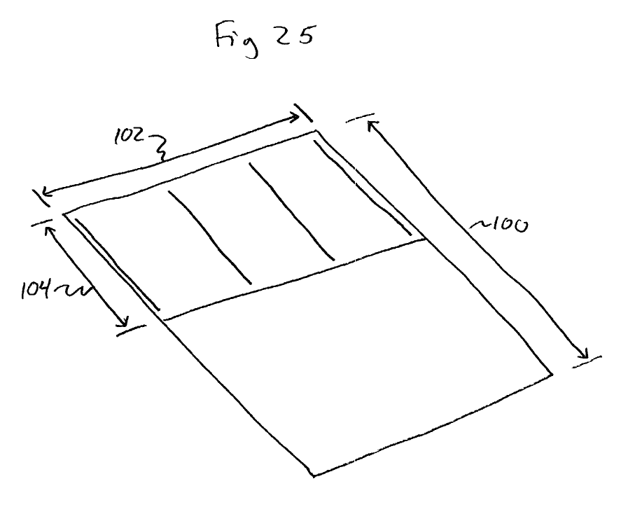

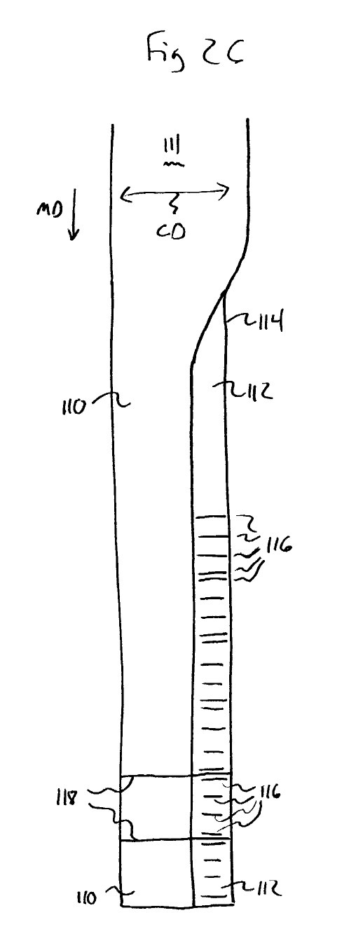

In another modification, referring to FIG. 22, the upper portion 76 of the wipe product may be separated into two or more parts 77 and 78. This particular configuration may be useful in providing the user with a feel which is more like a conventional glove. A wipe product similar to that shown in FIG. 22 may be produced by a variety of methods. For example, referring to the sequence of FIGS. 21 and 22, the primary and secondary sheets may be cut to have space 80, positioned together, and then bonded. Although these figures illustrate the folding of a single sheet of material, a similar process can be performed using separate sheets of material for the primary and secondary sheets. In another example, referring to the sequence of FIGS. 23 and 24, at least one of the intermittent bonds (82) can be made wide enough that the product can be cut along the bond to form space 84.

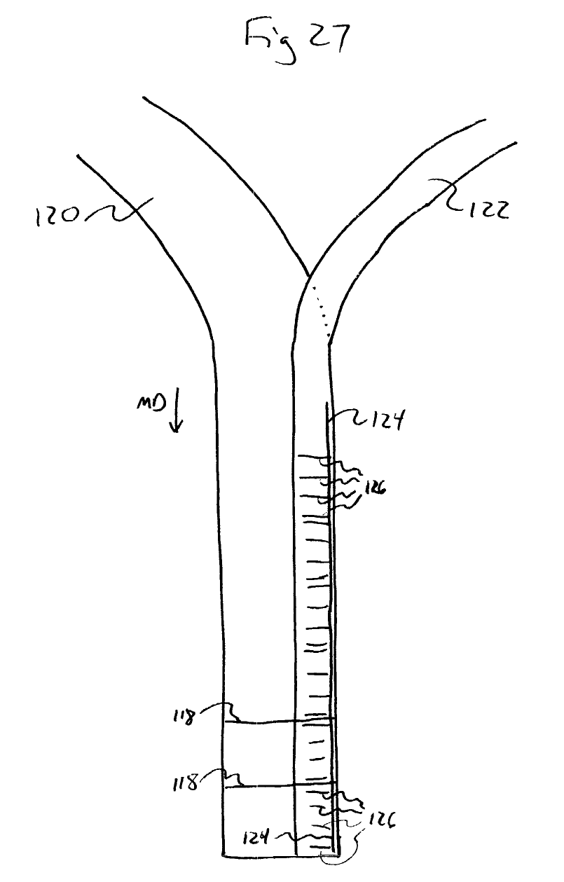

The dimensions of the wipe product, the primary and secondary sheets, and the bonds may all be varied to produce a desired wipe product. Referring to FIG. 25, for many personal care applications, it may be advantageous to provide a wipe product with a wipe length 100 of at least 3 inches (7.6 centimeters (cm)). The wipe length 100 may advantageously be at least 4.5 inches (11.4 cm), or at least 7.5 inches (19.1 cm). It may be advantageous for the wipe width 102 to be at least 3 inches (7.6 cm), or advantageously at least 5 inches (12.7 cm) or at least 7.5 inches (19.1 cm). It may be advantageous for the length 104 of the secondary sheet to be at least 0.5 inch (1.3 cm). The length 104 of the secondary sheet may advantageously be between 0.5 and 10 inches (25.4 cm). The length 104 of the secondary sheet may advantageously be between 2.5 (6.4 cm) and 10 inches.

Disposable wipe products can be made individually, or they can be made in multiples in a manufacturing process. In a manufacturing process, the primary and secondary sheets may be provided as sheet materials, for example from a sheet forming machine or from a reel of sheet material. In one example, referring to FIG. 26, a single sheet of material 111 is provided traveling in a machine direction (MD). At least one side of the sheet is folded in the cross direction (CD), along a fold line 114 in the machine direction, to produce the secondary sheet 112 over the primary sheet 110. The primary and secondary sheets are then bonded together with intermittent bonds 116. The intermittent bonds are placed at an angle relative to the machine direction. In the illustrated example, the intermittent bonds are substantially perpendicular to the machine direction. Individual wipe products are then provided by cutting or perforating along line 118 in the cross direction. The cut or perforation line 118 can also be placed so as to pass through a bond rather than passing between two bonds.

As discussed above, the primary and secondary sheets can be provided as separate sheets of material. Referring to FIG. 27, these sheets are placed together, bonded, and then cut or perforated to provide individual wipe products. Primary sheet 120 and secondary sheet 122 are stylistically shown as converging and then traveling together in the machine direction. Upper edge bond 124 can be formed before, during, or after the formation of intermittent bonds 126. Upper edge bond 124 can be continuous as illustrated or can be discontinuous. This process can also be extended, with multiple secondary sheets bonded to the primary sheet and spaced apart from each other in the cross direction (see FIG. 8). In both FIGS. 26 and 27, the cut or perforation line 118 separates individual wipes. Two lines of separation which do not have another line of separation between them are referred to as “proximal separations”.

Wipe products with non-linear edges can be produced by cutting the sheet or sheets which are fed into the process along the edges which are in the machine direction. Further finishing steps may also be performed on the wipe products, including embossing, printing, cutting, perforating, and treating with agents such as additives, binders, or moisture. The final product can be provided, for example, as a stack of separate wipe products, as a stack of wipe products separable along lines of perforation, or as a roll of wipe products separable along lines of perforation.

Conventional paper processing machines can be used in the manufacture of wipe products. These machines include paper making machines, size presses, winding and unwinding reels, perforators, slitters, folders, bonders, and embossers. In making wipe products from a single sheet of material, it is useful to use a folding board to fold a side of the sheet, thus forming the primary and secondary sheets.

The process of making disposable wipe products as described takes advantage of existing technologies in the nonwovens and the consumer products industries. Thus, conventional paper sheets and conventional processing machines can be used to produce these wipe products. For example, a sheet of material can be folded using a folding board, such as described in U.S. Pat. No. 1,046,325. In another example, intermittent ultrasonic bonds can be formed as described in U.S. Pat. No. 6,123,792.

Because the primary and secondary sheets are formed by bonding sheets having the same dimensions in the machine direction, the primary and secondary sheets in the final wipe product have substantially equivalent width dimensions (see element 102 in FIG. 25). Because the primary and secondary sheets do not need to be cut in custom shapes to provide the finger pockets, the wipe products are easy and inexpensive to manufacture. Unlike other inexpensive wipes (i.e. “mitten” products), the wipe products provide good control of the cleaning process due to the presence of the finger pockets.

Disposable wipe products as described provide for optimum coverage of a user's hand during a cleaning process. These wipe products further provide for control of the wipe during use. The configurations of the disposable wipe products may further allow a user's hand to be inserted into the wipe without the use of the user's other hand, and the wipe product may be disposed of simply by releasing the wipe from the hand which has been inserted into the wipe. Thus, a user can easily insert a hand into a wipe product, clean a surface in a controlled manner and with optimum coverage of the hand used for the cleaning, and can easily deposit the used wipe product into a waste container without the use of the other hand.

1. A disposable wipe product, comprising:
a primary sheet comprising an upper edge, a lower edge, a right side edge, a left side edge, and a width extending between the side edges;
a secondary sheet comprising an upper edge, a lower edge, a right side edge, a left side edge, and a width extending between the side edges;
at least a portion of the upper edge of the primary sheet connected to at least a portion of the upper edge of the secondary sheet; at least a portion of the right side edge of the primary sheet connected to at least a portion of the right side edge of the secondary sheet; and at least a portion of the left side edge of the primary sheet connected to at least a portion of the left side edge of the secondary sheet;
at least one bond connecting the width of the primary sheet with the width of the secondary sheet;
a space between the right side edges and the at least one bond; and
a space between the left side edges and the at least one bond;
wherein the at least one bond is positioned between the right side edges and the left side edges, and the width of the primary sheet is about equal to the width of the secondary sheet.

2. The wipe product of claim 1, comprising at least two bonds connecting the width of the primary sheet with the width of the secondary sheet.

3. The wipe product of claim 1, comprising at least three bonds connecting the width of the primary sheet with the width of the secondary sheet.

4. The wipe product of claim 1, comprising at least four bonds connecting the width of the primary sheet with the width of the secondary sheet.

5. The wipe product of claim 1, wherein the primary sheet is an absorbent material.

6. The wipe product of claim 1, wherein the secondary sheet is an absorbent material.

7. The wipe product of claim 1, wherein the primary sheet and secondary sheet are nonwoven.

8. The wipe product of claim 1, wherein the upper edge of the primary sheet and the upper edge of the secondary sheet are connected by a fold.

9. The wipe product of claim 1, wherein the upper edge of the primary sheet and the upper edge of the secondary sheet are connected by a bond.

10. The wipe product of claim 1, further comprising a tertiary sheet, comprising an upper edge, a lower edge, a right side edge, a left side edge, and a width extending between the side edges;
at least a portion of the lower edge of the primary sheet connected to at least a portion of the upper edge of the tertiary sheet; at least a portion of the right side edge of the primary sheet connected to at least a portion of the right side edge of the tertiary sheet; and at least a portion of the left side edge of the primary sheet connected to at least a portion of the left side edge of the tertiary sheet; and
at least one bond connecting the width of the primary sheet with the width of the tertiary sheet;
wherein the at least one bond is positioned between the right side edges and the left side edges, and the width of the primary sheet is about equal to the width of the tertiary sheet.

11. The wipe product of claim 10, wherein the primary sheet has a first side and a second side; the secondary sheet connected to the first side, and the tertiary sheet connected to the second side.

12. The wipe product of claim 10, wherein the primary sheet has a first side and a second side; the secondary sheet and the tertiary sheet connected to the first side.

13. The wipe product of claim 1, wherein the primary sheet has a length of at least about 3 inches, the secondary sheet has a length of at least about 0.5 inch, and the wipe product has a width of at least 3 inches.

14. A method of making a wipe product, comprising:
providing a primary sheet and a secondary sheet; the primary sheet comprising an upper edge, a lower edge, a right side edge, a left side edge, and a width extending between the side edges; the secondary sheet comprising an upper edge, a lower edge, a right side edge, a left side edge, and a width extending between the side edges;
at least a portion of the upper edge of the primary sheet connected to at least a portion of the upper edge of the secondary sheet; and the width of the primary sheet about equal to the width of the secondary sheet;
connecting at least a portion of the right side edge of the primary sheet to at least a portion of the right side edge of the secondary sheet;
connecting at least a portion of the left side edge of the primary sheet to at least a portion of the left side edge of the secondary sheet; and
forming at least two spaces by connecting the primary sheet with the secondary sheet at one or more positions between the right side edges and the left side edges.

15. The method of claim 14, wherein the providing comprises folding a sheet of material along a line to form the primary sheet and the secondary sheet; wherein the primary sheet and the secondary sheet are at least partially connected along the line.

16. The method of claim 14, wherein the providing comprises bonding at least a portion of the upper edge of the primary sheet with at least a portion of the upper edge of the secondary sheet.

17. The method of claim 14, wherein the forming at least two spaces comprises forming three spaces by connecting the primary sheet with the secondary sheet at two positions between the right side edges and the left side edges.

18. The method of claim 14, wherein the forming at least two spaces comprises forming four spaces by connecting the primary sheet with the secondary sheet at three positions between the right side edges and the left side edges.

19. The method of claim 14, wherein the forming at least two spaces comprises forming five spaces by connecting the primary sheet with the secondary sheet at four positions between the right side edges and the left side edges.

20. The method of claim 14, wherein the connecting at least a portion of the right side edge comprises application of adhesives, thermal bonding, taping, mechanical fastening, ultrasonic bonding, or entanglement of elements of the sheets.

21. The method of claim 14, wherein the connecting at least a portion of the left side edge comprises application of adhesives, thermal bonding, taping, mechanical fastening, ultrasonic bonding, or entanglement of elements of the sheets.

22. The method of claim 14, wherein the forming at least two spaces comprises application of adhesives, thermal bonding, taping, mechanical fastening, ultrasonic bonding, or entanglement of elements of the sheets.

23. The method of claim 16, wherein the bonding at least a portion of the upper edge comprises application of adhesives, thermal bonding, taping, mechanical fastening, ultrasonic bonding, or entanglement of elements of the sheets.

24. The method of claim 14, wherein the primary sheet comprises a first width extending between the side edges; the secondary sheet comprises a second width extending between the side edges; and the first width is about equal to the second width

25. The method of claim 14, wherein the primary sheet and secondary sheet are nonwoven.

26. A method of making a plurality of wipe products, comprising:
providing a primary sheet and a secondary sheet traveling in a machine direction; the primary sheet comprising an upper edge and a lower edge; the secondary sheet comprising an upper edge and a lower edge; at least a portion of the upper edge of the primary sheet connected to at least a portion of the upper edge of the secondary sheet;
connecting the primary sheet and the secondary sheet with intermittent bonds at an angle relative to the machine direction; and
forming a plurality of separations in a cross direction perpendicular to the machine direction;
wherein, in a region between two proximal separations, at least two pockets are positioned between the intermittent bonds.

27. The method of claim 26, wherein the forming a plurality of separations comprises cutting the primary and secondary sheets in the cross direction.

28. The method of claim 26, wherein the forming a plurality of separations comprises perforating the primary and secondary sheets in the cross direction.

29. The method of claim 26, wherein the providing comprises folding a sheet of material along a line in the machine direction to form the primary sheet and the secondary sheet; wherein the primary sheet and the secondary sheet are at least partially connected along the line.

30. The method of claim 26, wherein the providing comprises bonding at least a portion of the upper edge of the primary sheet with at least a portion of the upper edge of the secondary sheet with an edge bond in the machine direction.

31. The method of claim 26, wherein three pockets are positioned between the intermittent bonds.

32. The method of claim 26, wherein four pockets are positioned between the intermittent bonds.

33. The method of claim 26, wherein five pockets are positioned between the intermittent bonds.

34. The method of claim 26, wherein the connecting the primary sheet and the secondary sheet with intermittent bonds comprises application of adhesives, thermal bonding, taping, mechanical fastening, ultrasonic bonding, or entanglement of elements of the sheets.

35. The method of claim 30, wherein the bonding the upper edge comprises application of adhesives, thermal bonding, taping, mechanical fastening, ultrasonic bonding, or entanglement of elements of the sheets.

36. The method of claim 26, wherein the primary sheet and secondary sheet are nonwoven.

37. A disposable wipe product, comprising:
a primary sheet comprising an upper edge, a lower edge, a right side edge, a left side edge, and a width extending between the side edges;
a secondary sheet comprising an upper edge, a lower edge, a right side edge, a left side edge, and a width extending between the side edges;
wherein at least a portion of the upper edge of the primary sheet is connected to at least a portion of the upper edge of the secondary sheet; and the width of the primary sheet is about equal to the width of the secondary sheet;
a first bond, connecting the width of the primary sheet with the width of the secondary sheet near the right side edges;
a second bond, connecting the width of the primary sheet with the width of the secondary sheet near the left side edges;
a third bond, connecting the width of the primary sheet with the width of the secondary sheet and positioned between the first and second bonds;
at least one space between the first bond and the third bond; and
at least one space between the second bond and the third bond.

38. The wipe product of claim 37, wherein the primary sheet and secondary sheet are nonwoven.

39. The wipe product of claim 37, further comprising a fourth bond, connecting the width of the primary sheet with the width of the secondary sheet and positioned between the first bond and the third bond;
at least one space between the first bond and the fourth bond; and
at least one space between the third bond and the fourth bond.

40. The wipe product of claim 37, further comprising a fifth bond, connecting the width of the primary sheet with the width of the secondary sheet and positioned between the second bond and the third bond;
at least one space between the second bond and the fifth bond; and
at least one space between the third bond and the fifth bond.

41. The wipe product of claim 39, further comprising a fifth bond, connecting the width of the primary sheet with the width of the secondary sheet and positioned between the second bond and the third bond;
at least one space between the second bond and the fifth bond; and
at least one space between the third bond and the fifth bond.

42. A method of making a wipe product, comprising:
providing a primary sheet and a secondary sheet; the primary sheet comprising an upper edge, a lower edge, a right side edge, and a left side edge; the secondary sheet comprising an upper edge, a lower edge, a right side edge, and a left side edge; at least a portion of the upper edge of the primary sheet connected to at least a portion of the upper edge of the secondary sheet;
forming a first bond to connect the width of the primary sheet with the width of the secondary sheet near the right side edges;
forming a second bond to connect the width of the primary sheet with the width of the secondary sheet near the left side edges; and
forming a third bond to connect the width of the primary sheet with the width of the secondary sheet at a position between the first and second bonds;
wherein the first bond and the third bond are separated by at least one space; the second bond and the third bond are separated by at least one space; and the width of the primary sheet is about equal to the width of the secondary sheet.

43. The method of claim 42, further comprising forming a fourth bond to connect the width of the primary sheet with the width of the secondary sheet at a position between the first and third bonds;
wherein the first bond and the fourth bond are separated by at least one space; and the fourth bond and the third bond are separated by at least one space.

44. The method of claim 42, further comprising forming a fifth bond to connect the width of the primary sheet with the width of the secondary sheet at a position between the second and third bonds;
wherein the second bond and the fifth bond are separated by at least one space; and the fifth bond and the third bond are separated by at least one space.

45. The method of claim 42, wherein the forming a first bond, the forming a second bond, and the forming a third bond independently comprise a member selected from the group consisting of applying adhesives, thermal bonding, taping, mechanical fastening, ultrasonic bonding, and entangling of elements of the sheets.

46. The method of claim 42, wherein the primary sheet and secondary sheet are nonwoven.

47. A disposable wipe product, consisting essentially of:
a primary sheet comprising an upper edge, a lower edge, a right side edge, and a left side edge;
a secondary sheet comprising an upper edge, a lower edge, a right side edge, and a left side edge;
at least a portion of the upper edge of the primary sheet connected to at least a portion of the upper edge of the secondary sheet; at least a portion of the right side edge of the primary sheet connected to at least a portion of the right side edge of the secondary sheet; and at least a portion of the left side edge of the primary sheet connected to at least a portion of the left side edge of the secondary sheet;
a bond connecting the primary sheet with the secondary sheet and positioned between the right side edges and the left side edges;
a space between the right side edges and the bond; and
a space between the left side edges and the bond.

48. A disposable wipe product, comprising:
a primary sheet comprising an upper edge, a lower edge, a right side edge, and a left side edge;
a secondary sheet comprising an upper edge, a lower edge, a right side edge, and a left side edge;
at least a portion of the upper edge of the primary sheet connected to at least a portion of the upper edge of the secondary sheet; at least a portion of the right side edge of the primary sheet connected to at least a portion of the right side edge of the secondary sheet; and at least a portion of the left side edge of the primary sheet connected to at least a portion of the left side edge of the secondary sheet;
at least one bond connecting the primary sheet with the secondary sheet;
a space between the right side edges and the at least one bond; and
a space between the left side edges and the at least one bond;
wherein the at least one bond is positioned between the right side edges and the left side edges, and the at least one bond and the upper edges are not adjacent.
